(19) United States
(12) Patent Application Publication
(10) Pub. No.: US 2018/0268958 A1
(43) Pub. Date: Sep. 20, 2018

(54) ELECTRICAL WIRE AND TERMINAL-EQUIPPED ELECTRICAL WIRE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Naoki AOYAMA, Yokkaichi, Mie (JP); Masaharu SUETANI, Yokkaichi, Mie (JP); Kentaro TACHI, Yokkaichi, Mie (JP)

(21) Appl. No.: 15/542,160

(22) PCT Filed: Dec. 18, 2015
(86) PCT No.: PCT/JP2015/085485

§ 371 Date: Jul. 7, 2017

(30) Foreign Application Priority Data
Jan. 7, 2015 (JP) 2015-001410

(51) Int. Cl. H01B 7/02; H01B 7/04; H01R 4/72; H01B 7/08

(52) U.S. Cl. CPC H01B 7/02; H01B 7/08; H01R 4/72; H01B 7/04

(57) ABSTRACT

A electrical wire with improved flexibility that is provided with a metal conductor and an insulating member that wraps around the conductor. The electrical wire includes a conductor portion that is flexible and is made of metal; and an insulating member that wraps around the conductor portion. An inner surface of the insulating member and an outer surface of the conductor portion are provided so as to be separable from each other. Also, it is possible that, in at least some portions of the electrical wire, a space is provided between the inner surface of the insulating member and the outer surfaces of the conductor portion, for example.

### CROSS REFERENCE TO RELATED APPLICATIONS

This application claims the priority of Japanese patent application JP2015-001410 filed on Jan. 7, 2015, the entire contents of which are incorporated herein.

### TECHNICAL FIELD

The present invention relates to an electrical wire that is provided with a conducting portion and an insulating member, and a terminal-equipped electrical wire that is provided with the electrical wire and terminals.

### BACKGROUND ART

In wire harnesses that are to be mounted on a vehicle such as an automobile, there are cases in which an insulating member is provided around a metal conductor (a bus bar), as shown in Patent Document 1, for example. In an example shown in Patent Document 1, a bus bar has a laminated structure, and is flexible in the thickness direction thereof.

Also, in the example shown in Patent Document 1 (JP2012-182047A), an insulating member is a member that wraps around an intermediate area of the bus bar, excluding the two end portions thereof, and that is flexible. The insulating member is formed by performing insertion molding, with the intermediate area of the bus bar serving as an inserted portion.

Also, Patent Document 2 (JP2010-135203A) shows a flat electrical wire that is provided with: a plurality of electrical wire portions that are constituted by a plurality of strands that are arranged in parallel so as to be in contact with each other; and an insulating member that is formed by performing extrusion molding and covers the plurality of electrical wire portions.

### SUMMARY

In the example shown in Patent Document 1, the insulating member formed by performing insertion molding is fixed to the outer circumferential surface of the metal conductor (the bus bar), and therefore the insulating member prevents the bus bar from bending, despite the insulating member being a flexible member.

Also in the example shown in Patent Document 2, the insulating member is fixed to and wraps around the electrical wire portions that are constituted by the plurality of strands that are in contact with each other, and thus the insulating member that wraps around the electrical wire portions prevents the electrical wire portions from deforming.

Therefore, the present design aims to provide technology for improving the flexibility of an electrical wire that is provided with a metal conductor and an insulating member that wraps around the conductor.

An electrical wire according to a first aspect includes: a conductor portion that is flexible and is made of metal; and an insulating member that wraps around the conductor portion, wherein an inner surface of the insulating member and an outer surface of the conductor portion are provided so as to be separable from each other.

An electrical wire according to a second aspect is an aspect of the electrical wire according to the first aspect. In the electrical wire according to the second aspect, in at least some portions of the electrical wire, a space is provided between the inner surface of the insulating member and the outer surface of the conductor portion.

An electrical wire according to a third aspect is an aspect of the electrical wire according to the first aspect or the second aspect. In the electrical wire according to the third aspect, the insulating member has a bellow structure in which ridge portions that are convex and extend in a direction that intersects a lengthwise direction of the conductor portion, and valley portions that are concave and extend in a direction that intersects the lengthwise direction of the conductor portion, are alternately and continuously arranged in the lengthwise direction of the conductor portion.

An electrical wire according to a fourth aspect is an aspect of the electrical wire according to the third aspect. In the electrical wire according to the fourth aspect, spaces are formed between inner surfaces of the ridge portions of the insulating member and the outer surface of the conductor portion.

An electrical wire according to a fifth aspect is an aspect of the electrical wire according to any one of the first aspect to the fourth aspect. In the electrical wire according to the fifth aspect, the insulating member includes a first insulating member and a second insulating member that wrap around the conductor portion by being brought closer to the conductor portion from both sides and being joined to each other on both sides of the conductor portion.

An electrical wire according to a sixth aspect is an aspect of the electrical wire according to the fifth aspect. In the electrical wire according to the sixth aspect, the first insulating member and the second insulating member are film members that are made of resin, and the insulating member includes the first insulating member and the second insulating member that are joined to each other.

An electrical wire according to a seventh aspect is an aspect of the electrical wire according to the fifth aspect. In the electrical wire according to the seventh aspect, the insulating member includes the first insulating member and the second insulating member that are molded members made of resin, and at least one of the first insulating member and the second insulating member is provided with a groove portion that allows the conductor portion to be disposed therein.

An electrical wire according to an eight aspect is an aspect of the electrical wire according to any one of the fifth aspect to the seventh aspect. In the electrical wire according to the eighth aspect, the conductor portion is provided in a plurality, the plurality of conductors being arranged in parallel, and the insulating member that wraps around the plurality of conductor portions together includes partition portions that are joined portions between adjacent conductor portions, and that separate the plurality of conductor portions from each other.

An electrical wire according to a ninth aspect is an aspect of the electrical wire according to the first aspect or the second aspect. In the electrical wire according to the ninth aspect, the insulating member is a heat shrink tube that has shrunk due to heat having been applied thereto, and includes: intimate contact portions that are located at two end portions of the insulating member, have shrunk due to heat having been applied thereto, and are in intimate contact with a circumferential surface of the conductor portion; and a space forming portion that is a portion between the intimate contact portions and is in a pre-shrinkage state.

A terminal-equipped electrical wire according to a tenth aspect includes: the electrical wire according to the first aspect or the second aspect; and terminals that are respectively connected to two end portions of the conductor, wherein the insulating member is a heat shrink tube whose two end portions are respectively in intimate contact with circumferential surfaces of the terminals and have shrunk due to heat having been applied thereto.

A terminal-equipped electrical wire according to an eleventh aspect is an aspect of the terminal-equipped electrical wire according to the tenth aspect. In the terminal-equipped electrical wire according to the eleventh aspect, the insulating member includes: intimate contact portions that are located at two end portions of the insulating member and have shrunk due to heat having been applied thereto; and a space forming portion that is a portion between the intimate contact portions and is in a pre-shrinkage state, the intimate contact portions are in intimate contact with the circumferential surfaces of the terminals, and a contour of an inner surface of the space forming portion is larger than a contour of the conductor portion, and a space is formed between the inner surface of the space forming portion and an outer surface of the conductor portion.

A terminal-equipped electrical wire according to a twelfth aspect is an aspect of the terminal-equipped electrical wire according to the tenth aspect. In the terminal-equipped electrical wire according to the twelfth aspect, the terminals respectively include insulating member fixing portions whose contours are larger than a contour of the conductor portion, and the insulating member is a heat shrink tube that has shrunk along an entire length thereof due to heat having been applied thereto, and includes: intimate contact portions that are in intimate contact with circumferential surfaces of the insulating member fixing portions of the terminals; and a space forming portion whose inner surface after heat shrinkage has a contour that is larger than a contour of the conductor portion so that a space is formed between the space forming portion and an outer surface of the conductor portion.

In each of the above-described aspects, the inner surface of the insulating member and the outer surface of the conductor portion are provided so as to be separable from each other. That is to say, the insulating member is not fixed to the outer surface of the conductor portion. In this case, in the insulating member, portions that are located on the inner side of the conductor portion in the bending direction and the portions that are located on the outer side in the bending direction deform at positions that correspond to the deformation of the conductor portion. Therefore, it is possible to reduce the force required to bend the electrical wire, and it is possible to further improve the flexibility of the electrical wire.

Also, according to the second aspect, in at least some portions of the electrical wire, a space is provided between the inner surface of the insulating member and the outer surface of the conductor portion. In this case, a space that does not prevent the conductor portion from bending can be formed between the insulating member and the conductor portion, and it is possible to further improve the flexibility of the electrical wire.

Also, according to the third aspect, the insulating member has a bellow structure in which ridge portions that are convex and extend in an intersecting direction that intersects a lengthwise direction of the conductor portion, and valley portions that are concave and extend in the intersecting direction, are alternately and continuously arranged in the lengthwise direction of the conductor portion, and therefore it is easier to bend the insulating member in a direction in which the two ends of the conductor portion are brought closer to each other.

Also, according to the fourth aspect, spaces are formed between inner surfaces of the ridge portions of the insulating member and the outer surface of the conductor portion. In this case, sufficient spaces are formed between the insulating member and the conductor portion, and therefore it is possible to further improve the flexibility of the electrical wire.

Also, in the fifth aspect, the insulating member includes a first insulating member and a second insulating member that wrap around the conductor portion by being brought closer to the conductor portion from both sides and being joined to each other on both sides of the conductor portion. In this case, it is possible to attach the insulating member to the conductor portion by performing a simple task of attaching the insulating member to the conductor portion so as to sandwich the conductor portion from both sides.

Also, according to the sixth aspect, the first insulating member and the second insulating member are films that are made of resin, and the insulating member includes the first insulating member and the second insulating member that are joined to each other by performing welding. In this case, it is possible to easily attach the insulating member to the conductor portion by performing welding in a situation where the first insulating member and the second insulating member have been placed on each other.

Also, according to the seventh aspect, the insulating member includes the first insulating member and the second insulating member that are molded members made of resin, and at least one of the first insulating member and the second insulating member is provided with a groove portion that allows the conductor portion to be disposed therein. In this case, it is possible to attach the insulating member to the conductor portion by performing a simple task of attaching the first insulating member and the second insulating member to the conductor portion so as to sandwich the conductor portion from both sides.

Also, according to the eighth aspect, the conductor portion includes a plurality of conductor portions that are arranged in parallel. Also, the insulating member includes partition portions that are joined portions between adjacent conductor portions, and that separate the plurality of conductor portions from each other. In this case, it is possible to integrate a plurality of electrical wire portions into one piece using the insulating member, and improve performance when handling the electrical wire. Also, it is possible to prevent the conductor portion from interfering with another conductor portion, using the partition portions.

Also, according to the ninth aspect, the insulating member is a heat shrink tube that has shrunk due to heat having been applied thereto, and includes: intimate contact portions that are located at two end portions of the insulating member, have shrunk due to heat having been applied thereto, and are in intimate contact with a circumferential surface of the conductor portion; and a space forming portion that is a portion between the intimate contact portions and is in a pre-shrinkage state. In this case, it is possible to attach the insulating member to the conductor portion by applying heat to the end portions of the heat shrink tube to shrink the end portions. That is to say, there is no need to apply heat to the entire heat shrink tube, and it is possible to reduce the time that is required to manufacture the electrical wire.

Also, according to the tenth aspect, the insulating member is a heat shrink tube whose two end portions are respectively in intimate contact with circumferential surfaces of the terminals, and have shrunk due to heat having been applied thereto. In this case, it is possible to attach the insulating member to the conductor portion by performing a simple task of applying heat to the heat shrink tube to shrink the heat shrink tube.

Also, according to the eleventh aspect, the insulating member includes: intimate contact portions that are located at two end portions of the insulating member and have shrunk due to heat having been applied thereto; and a space forming portion that is a portion between the intimate contact portions and is in a pre-shrinkage state. In this case, it is possible to attach the insulating member to the conductor portion by applying heat to the end portions of the heat shrink tube to shrink the end portions. That is to say, there is no need to apply heat to the entire heat shrink tube, and it is possible to reduce the time that is required to manufacture the terminal-equipped electrical wire.

Also, according to the twelfth aspect, the insulating member is a heat shrink tube that has shrunk along the entire length thereof due to heat having been applied thereto, and includes: intimate contact portions that are in intimate contact with circumferential surfaces of the insulating member fixing portions of the terminals; and a space forming portion whose inner surface has a contour that is larger than a contour of the conductor portion so that a space is formed between the space forming portion and an outer surface of the conductor portion. In this case, it is possible to attach the insulating member to the conductor portion by performing a simple task of applying heat to the entire heat shrink tube to shrink the heat shrink tube.

### BRIEF DESCRIPTION OF DRAWINGS

FIG. 1 is a plan view of an electrical wire according to a first embodiment.

FIG. 2 is a partially-cutout side view of an end portion of the electrical wire according to the first embodiment.

FIG. 3 is a cross-sectional view of the electrical wire according to the first embodiment.

FIG. 4 is a partially-cutout perspective view of the electrical wire according to the first embodiment.

FIG. 5 is a cross-sectional view of the electrical wire according to the first embodiment.

FIG. 6 is a plan view of an electrical wire according to a second embodiment.

FIG. 7 is a partially-cutout side view of an end portion of the electrical wire according to the second embodiment.

FIG. 8 is a partially-cutout side view of the end portion of the electrical wire according to the second embodiment.

FIG. 9 is a cross-sectional view of the electrical wire according to the second embodiment.

FIG. 10 is a cross-sectional view of the electrical wire according to the second embodiment.

FIG. 11 is a cross-sectional view of the electrical wire according to the second embodiment.

FIG. 12 is a plan view of terminal-equipped electrical wires according to a third embodiment.

FIG. 13 is a cross-sectional view of the terminal-equipped electrical wires according to the third embodiment.

FIG. 14 is a partially-cutout side view of an end portion of a terminal-equipped electrical wire according to the third embodiment in a partially-disassembled state.

FIG. 15 is a partially-cutout side view of the end portion of the terminal-equipped electrical wire according to the third embodiment.

FIG. 16 is a plan view of terminal-equipped electrical wires according to a fourth embodiment.

FIG. 17 is a cross-sectional view of the terminal-equipped electrical wires according to the fourth embodiment.

FIG. 18 is a partially-cutout side view of an end portion of a terminal-equipped electrical wire according to the fourth embodiment in a partially-disassembled state.

FIG. 19 is a partially-cutout side view of the end portion of the terminal-equipped electrical wire according to the fourth embodiment.

FIG. 20 is a partially-cutout side view of an electrical wire according to a fifth embodiment.

FIG. 21 is a partially-cutout side view of an end portion of the electrical wire according to the fifth embodiment in a partially-disassembled state.

FIG. 22 is a cross-sectional view of an electrical wire according to a referential example.

FIG. 23 is a partially-cutout side view of the electrical wire according to the referential example.

### DESCRIPTION OF EMBODIMENTS

The following describes embodiments with reference to the accompanying drawings. The embodiments shown below are specific examples of the present invention, and they do not limit the technical scope of the present invention.

### First Embodiment

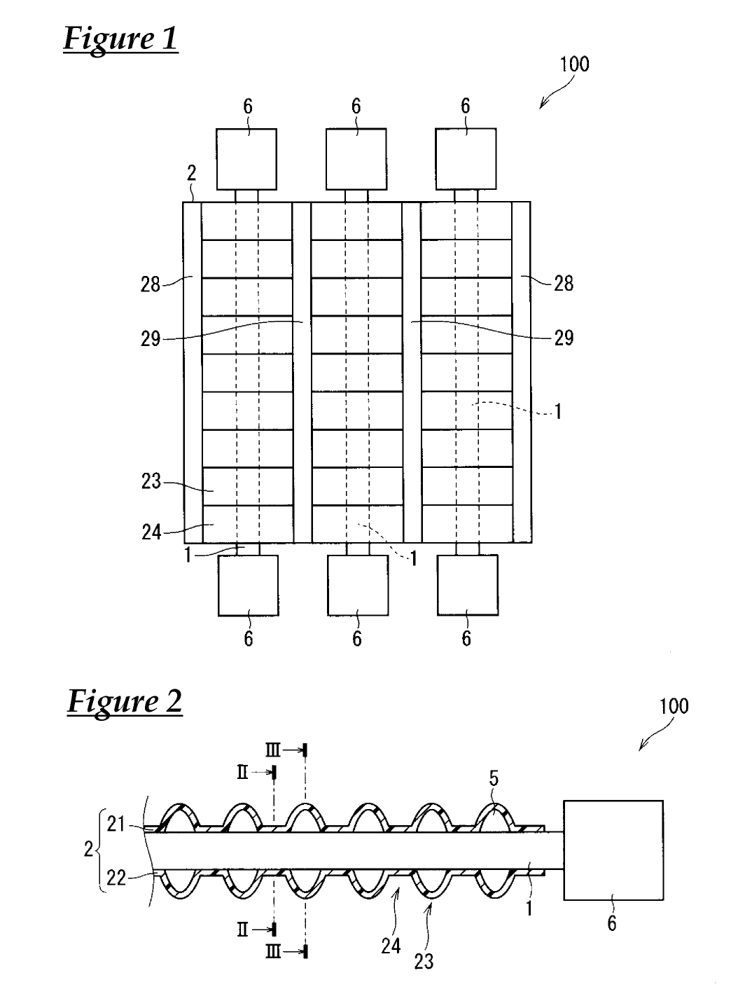

An electrical wire 100 according to a first embodiment will be described with reference to FIGS. 1 to 5. The electrical wire 100 includes conductor portions 1 and an insulating member 2. Also, in the present embodiment, connection members 6 are connected to end portions of the conductor portions 1. The electrical wire 100 is to be mounted on, for example, a vehicle such as an automobile.

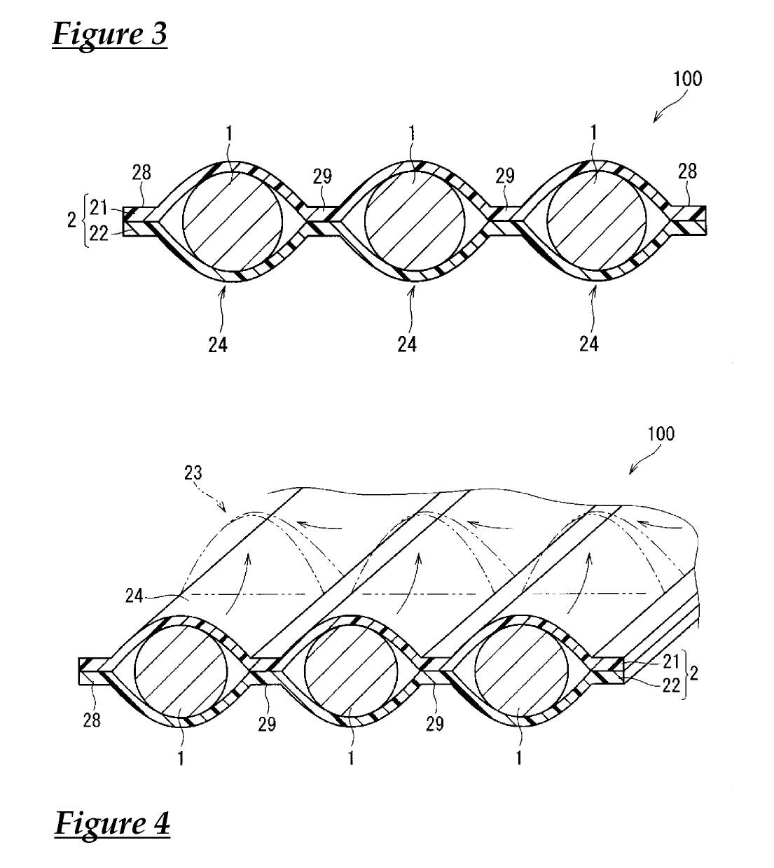

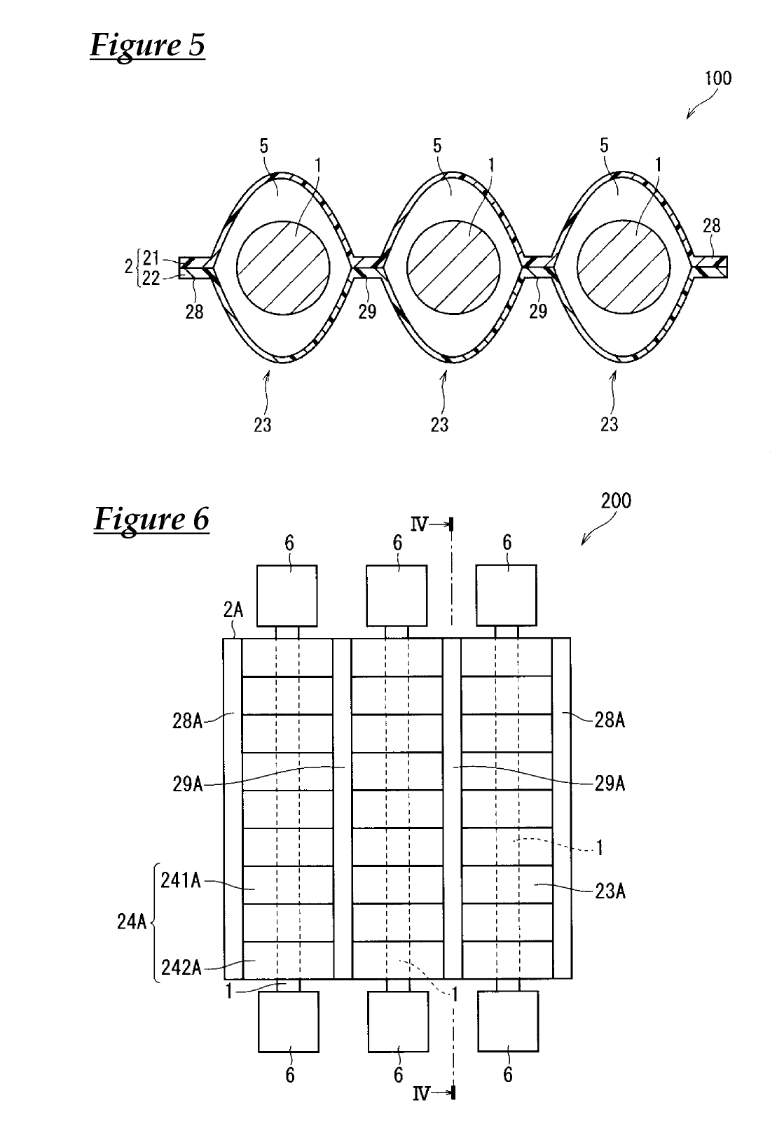

FIG. 1 is a plan view of the electrical wire 100. FIG. 2 is a partially-cutout side view of an end portion of the electrical wire 100. FIG. 3 is a cross-sectional view of the electrical wire 100. FIG. 3 is a cross-sectional view of the electrical wire 100 along a II-II plane shown in FIG. 2. FIG. 4 is a partially-cutout perspective view of the insulating member 2. FIG. 5 is a cross-sectional view of the electrical wire 100. FIG. 5 is a cross-sectional view of the electrical wire 100 along a plane shown in FIG. 2.

In the electrical wire 100, the conductor portions 1 are flexible metal members. That is to say, the conductor portions 1 in the electrical wire 100 are bare conductors. It is possible that the conductor portions 1 are braided wires, for example. Note that it is also possible that the conductor portions 1 are rod-shaped members that contain a flexible metal. It is also possible that the conductor portions 1 contain a plurality of thin linear bare conductors that are twisted together.

In the present embodiment, the connection members 6 are connected to end portions of the conductor portions 1 as shown in FIGS. 1 and 2. It is possible that the connection members 6 are terminals or terminal members such as connectors.

In the present embodiment, the conductor portions 1 include a plurality of conductor portions 1 that are arranged in parallel. As shown in FIG. 1, the present embodiment is an example in which three conductor portions 1 are integrated into one piece due to the presence of the insulating member 2. That is to say, the electrical wire 100 includes three conductor portions 1. Note that the number of conductor portions 1 included in the electrical wire 100 can be one, two, four, or more.

In the electrical wire 100, the insulating member 2 is a member that wraps around the conductor portions 1. In the electrical wire 100, the inner surface of the insulating member 2 and the outer surfaces of the conductor portions 1 are provided so as to be separable from each other. Note that, in the present embodiment, connection portions of the conductor portions 1, the connection portions being connected to the connection members 6, are not covered by the insulating member 2. It is also possible that the insulating member 2 covers the connection portions of the conductor portions 1 connected to the connection members 6.

In the present embodiment, the insulating member 2 includes a first insulating member 21 and a second insulating member 22. In the insulating member 2, the first insulating member 21 and the second insulating member 22 are brought closer to the conductor portions 1 from two sides, and are connected to each other on both sides of the conductor portions 1 so that the insulating member 2 wraps around the conductor portions 1. In the present embodiment, the insulating member 2 includes partition portions 29, external partition portions 28, ridge portions 23 that are convex, and valley portions 24 that are concave.

The present embodiment is an example in which the first insulating member 21 and the second insulating member 22 are film members that are made of resin, and the insulating member 2 includes the first insulating member 21 and the second insulating member 22 that are joined to each other. Note that, in the present embodiment, the first insulating member 21 and the second insulating member 22 are joined to each other through welding. The welded portions between the first insulating member 21 and the second insulating member 22 constitute the partition portions 29 and the external partition portions 28 of the insulating member 2.

In the present embodiment, the first insulating member 21 and the second insulating member 22 can be joined to each other through ultrasonic welding, heat welding, or the like. It is also possible that the first insulating member 21 and the second insulating member 22 in an overlapping state, are joined to each other by being processed by a lamination machine.

The first insulating member 21 and the second insulating member 22 are flat members prior to being welded. For example, it is possible that the first insulating member 21 and the second insulating member 22 are flexible members.

It is also possible that the first insulating member 21 and the second insulating member 22 are members that are made of a resin, and, for example, the first insulating member 21 and the second insulating member 22 are members that are made of a resin such as polyester, PA (polyamide), PI (polyimide), PE (polyethylene), or PP (polypropylene). Note that the first insulating member 21 and the second insulating member 22 may be members that are made of different resins, or members that are made of the same resin.

In the present embodiment, the insulating member 2 includes the partition portions 29 that are joined portions between adjacent conductor portions 1, and that separate a plurality of conductor portions 1 (three conductor portions 1 in this example) from each other. As shown in FIG. 1, in the present embodiment, the insulating member 2 includes two partition portions 29 that separate the three conductor portions 1 from each other.

In the present embodiment, the partition portions 29 are portions where the first insulating member 21 and the second insulating member 22 are welded to each other. Each partition portion 29 separates two conductor portions 1 that are located on the either side of the partition portion 29 from each other. Therefore, for example, as shown in FIG. 1, it is possible that the partition portions 29 are formed along the entire length of the insulating member 2 in the lengthwise direction of the conductor portions 1. It is also possible that the partition portions 29 are arranged in the manner of spots on the insulating member 2 in the lengthwise direction of the conductor portions 1, for example.

As shown in FIG. 1, in the present embodiment, the first insulating member 21 and the second insulating member 22 are also joined to each other at the two ends of the insulating member 2 in the direction in which the plurality of conductor portions 1 are arranged. These joined portions are the external partition portions 28. In the present embodiment, the external partition portions 28 are portions where the first insulating member 21 and the second insulating member 22 are welded to each other. In the following description, the direction in which the plurality of conductor portions 1 are arranged is referred to as a first direction.

As shown in FIGS. 1 and 3 to 5, the external partition portions 28 separate the conductor portions 1 that are located at the two ends in the first direction, from the outside. In the present embodiment, as shown in FIG. 1, the external partition portions 28 are formed along the entire length of the insulating member 2 in the lengthwise direction of the conductor portions 1, in the same manner as the partition portions 29. It is also possible that the external partition portions 28 are arranged in the manner of spots on the insulating member 2 in the lengthwise direction of the conductor portions 1, for example.

That is to say, in the present embodiment, two partition portions 29 and two external partition portions 28 are provided for the insulating member 2. Two conductor portions 1 out of the three conductor portions 1 are housed in the spaces that are each sandwiched between an external partition portion 28 and a partition portion 29, and the remaining one conductor portion 1 is housed in the space that is sandwiched between two partition portions 29. In the insulating member 2, each partition portion 29 prevents the conductor portions 1 that are located on either side of the partition portion 29 from interfering with each other. That is to say, the plurality of conductor portions 1 are prevented from being brought into contact with each other in the insulating member 2. Also, the external partition portions 28 prevent the conductor portions 1 and the insulating member 2 from detaching from each other.

Also, in the present embodiment, the partition portions 29 and the external partition portions 28 are formed so as to have flat surfaces. Note that it is possible that the partition portions 29 and the external partition portions 28 where the first insulating member 21 and the second insulating member 22 that are flexible are welded to each other are bendable portions. For example, it is possible that the partition portions 29 and the external partition portions 28 are flexible portions that have a thickness that allows the partition portions 29 and the external partition portions 28 to be bent so that the connection members 6 that are connected to the ends of the conductor portions 1 can be brought closer to each other.

In the electrical wire 100, the insulating member 2 includes the ridge portions 23 and the valley portions 24. The ridge portions 23 are formed along a direction that intersects the lengthwise direction of the conductor portions 1. Note that, in the following description, the direction that intersects the lengthwise direction of the conductor portions 1 is referred to as a second direction. The valley portions 24 are also formed in the second direction. The ridge portions 23 and the valley portions 24 are alternately and continuously formed in the lengthwise direction of the conductor portions 1. That is to say, the insulating member 2 has a bellow structure in which the ridge portions 23 that are convex and the valley portions 24 that are concave are alternately and continuously arranged in the lengthwise direction of the conductor portions 1.

Note that it is possible that the above-mentioned second direction is a direction that is orthogonal to the lengthwise direction of the conductor portions 1, or a direction that diagonally intersects the lengthwise direction of the conductor portions 1. For example, the second direction is the circumferential direction of the conductor portions 1, the widthwise direction of the conductor portions 1, or the like. Also, the second direction may be a direction that overlaps the first direction.

In the present embodiment, the valley portions 24 are concave on the outer surface side of the insulating member 2. That is to say, the valley portions 24 are formed as grooves that open outward when the valley portions 24 are viewed from the outer surface side of the insulating member 2.

Also, as shown in FIG. 3, in the electrical wire 100, the inner surfaces of the valley portions 24 are in contact with the outer surfaces of the conductor portions 1 that are housed in the insulating member 2, so as to be separable from the outer surfaces. The present embodiment shows a case in which, as shown in FIG. 3, some portions of the inner surfaces of the valley portions 24 are in contact with some portions of the outer surfaces of the conductor portions 1. That is to say, as shown in FIG. 3, in the electrical wire 100, the vertical size (the size in the thickness direction of the insulating member 2) of the contours of the inner surfaces of the valley portions 24 is equal to the vertical size of the contours of the outer surfaces of the conductor portions 1. Note that the horizontal size (the size in the width direction of the insulating member 2) of the contours of the inner surfaces of the valley portions 24 is larger than the horizontal size of the contours of the outer surfaces of the conductor portions 1. That is to say, in the present embodiment, the valley portions 24 of the insulating member 2 include inner surfaces that extend along some areas of the outer surfaces of the conductor portions 1.

Note that it is possible that the inner surfaces of the valley portions 24 are entirely in contact with the outer surfaces of the conductor portions 1. That is to say, it is also possible that the valley portions 24 of the insulating member 2 include inner surfaces that extend along the entire areas of the outer surfaces of the conductor portions 1. If this is the case, the vertical size and the horizontal size of the contours of the inner surfaces of the valley portions 24 are equal to the vertical size and the horizontal size of the contours of the outer surfaces of the conductor portions 1.

Also, the inner surfaces of the valley portions 24 and the outer surfaces of the conductor portions 1 are not joined, and are in contact with each other so as to be separable from each other. Therefore, when the electrical wire 100 is bent, the inner surfaces of the valley portions 24 and the outer surfaces of the conductor portions 1 of the insulating member 2 can be separated from each other by sliding along each other or moving so as to pass by each other. In this case, the insulating member 2 that wraps around the conductor portions 1 is easily deformed as the conductor portions 1 deform.

Also, in the present embodiment, the ridge portions 23 are curved and convex on the outer surface side of the insulating member 2. Each ridge portion 23 is formed such that the center thereof in the direction that connects adjacent partition portions 29 is at the highest position, and the ridge portion 23 curves such that the height gradually decreases in a direction moving away from the center to the partition portions 29, and thus a convex shape is formed. Also, as shown in FIG. 2, each ridge portion 23 is formed such that the center thereof between valley portions 24 that are adjacent in the first direction is at the highest position, and the ridge portion 23 curves such that the height gradually decreases in a direction moving away from the center to the valley portions 24, and thus a convex shape is formed.

Also, as shown in FIG. 2, when the ridge portions 23 are viewed from the inner surface side of the insulating member 2, the openings of the ridge portions 23 are formed as grooves that face toward the conductor portions 1 inside the insulating member 2. That is to say, in the present embodiment, in at least some portions, spaces 5 are provided between the inner surface of the insulating member 2 and the outer surfaces of the conductor portions 1. As shown in FIGS. 2 and 5, the spaces 5 are formed between the inner surfaces of the ridge portions 23 and the outer surfaces of the conductor portions 1.

By forming the spaces 5, it is possible to increase spaces that allow the conductor portions 1 to be freely deformed. That is to say, it is possible to secure sufficient spaces in which the conductor portions 1 can be deformed such that the outer surfaces of the conductor portions 1 are not brought into contact with the inner surface of the insulating member 2.

Also, in the present embodiment, the ridge portions 23 and the valley portions 24 are not formed on the partition portions 29 or the external partition portions 28. The ridge portions 23 and the valley portions 24 are respectively provided in portions each located between two partition portions 29, and in two portions each located between a partition portion 29 and an external partition portion 28. That is to say, in the present embodiment, the ridge portions 23 and the valley portions 24 are provided in some areas of the insulating member 2 in the second direction. Note that it is also possible that the ridge portions 23 and the valley portions 24 are provided along the entire length of the insulating member 2 in the second direction.

Also, as shown in FIG. 4, for example, the ridge portions 23 are formed by folding portions that are in contact with the outer surfaces of the conductor portions 1 in a state where the first insulating member 21 and the second insulating member 22 have been welded to each other. The following describes the process of attaching the insulating member 2 to the conductor portions 1.

First, in the present embodiment, the first insulating member 21 and the second insulating member 22, which are flat and flexible, are brought closer to each other from both sides of the conductor portions 1, and are placed on each other such that the plurality of conductor portions 1 (three conductor portions 1 in this example) are sandwiched therebetween all at once. Then, the first insulating member 21 and the second insulating member 22 are joined to each other, and the partition portions 29 and the external partition portions 28 are formed.

At this time, in the first insulating member 21 and the second insulating member 22 between which the conductor portions 1 are interposed, portions in which the conductor portions 1 are present bulge outward, and the inner surfaces of the first insulating member 21 and the second insulating member 22 are in contact with the outer surfaces of the conductor portions 1 along the entire length of the conductor portions 1 in the lengthwise direction. Then, the bulging portions of the first insulating member 21 and the second insulating member 22 in such a state are pinched or gathered while heat is applied thereto, and thus folds are formed. These multiple folds are provided at intervals in the lengthwise direction of the conductor portions 1, and thus the ridge portions 23 and the valley portions 24 are formed. That is to say, portions that include the folds and are externally formed so as to be convex constitute the ridge portions 23, and portions that are located between the folds and whose inner surfaces are in contact with the outer surfaces of the conductor portions 1 constitute the valley portions 24.

Note that the ridge portions 23 may be formed by moving mold members, which can be brought closer to each other in the lengthwise direction of the conductor portions 1, along the surfaces of the first insulating member 21 and the second insulating member 22, and pinching the first insulating member 21 and the second insulating member 22. Also, the insulating member 2 that has a bellow structure may be obtained by joining the first insulating member 21 and the second insulating member 22 on which the ridge portions 23 and the valley portions 24 have been formed in advance. If this is the case, the inner surfaces of the valley portions 24 of the first insulating member 21 and the inner surfaces of the valley portions 24 of the second insulating member 22 on both sides of the conductor portions 1 are joined, and thus the insulating member 2 provided with the ridge portions 23 and the valley portions 24 can be obtained.

In the present embodiment, the insulating member 2 has a bellow structure in which the ridge portions 23 and the valley portions 24 are alternately arranged in the lengthwise direction of the conductor portions 1. Therefore, the conductor portions 1 can be deformed such that the tops of the ridge portions 23 that are adjacent to each other, with the valley portions 24 therebetween, are brought closer to each other, and consequently it is easier to bend the insulating member 2 in a direction in which the ends of the conductor portions 1 are brought closer to each other.

In the electrical wire 100 that includes the conductor portions 1 and the insulating member 2, the inner surface of the insulating member 2 and the outer surfaces of the conductor portions 1 are provided so as to be separable from each other. That is to say, the insulating member 2 is not fixed to the outer surfaces of the conductor portions 1. Therefore, for example, when the electrical wire 100 is bent such that the first insulating member 21 is convex, the second insulating member 22 on the inner side of the bent conductor portions 1 (the inner side of the bending direction) deforms to shrink. Meanwhile, the first insulating member 21 on the outer side of the bent conductor portions 1 (the outer side of the bending direction) deforms to expand. That is to say, the inner surface of the insulating member 2 and the outer surfaces of the conductor portions 1 are separable from each other, and therefore the insulating member 2 that wraps around the conductor portions 1 deforms at positions that correspond to the deformation of the conductor portions 1. Consequently, it is possible to reduce the force required to bend the electrical wire 100, and it is possible to further improve the flexibility of the electrical wire 100.

Also, in the present embodiment, in at least some portions (the ridge portions 23 of the insulating member 2 in this example), spaces 5 are provided between the inner surface of the insulating member 2 and the outer surfaces of the conductor portions 1. In this case, the spaces 5 that do not prevent the conductor portions 1 from bending can be formed between the insulating member 2 and the conductor portions 1, and it is possible to further improve the flexibility of the electrical wire 100.

Also, in the present embodiment, the insulating member 2 has a bellow structure in which the ridge portions 23 that are convex and extend in the second direction that intersects the lengthwise direction of the conductor portions 1, and the valley portions 24 that are concave and extend in the second direction, are alternately and continuously arranged in the lengthwise direction of the conductor portions 1, and therefore it is easier to bend the insulating member 2 in a direction in which the ends of the conductor portions 1 are brought closer to each other.

Also, in the present embodiment, the insulating member 2 includes the first insulating member 21 and the second insulating member 22 that wrap around the conductor portions 1 by being brought closer to the conductor portions 1 from two sides, and being joined to each other on both sides of the conductor portions 1. In this case, it is possible to attach the insulating member 2 to the conductor portions 1 by performing a simple task of attaching the insulating member 2 to the conductor portions 1 so as to sandwich the conductor portions 1 from both sides. Also, joined portions between adjacent conductor portions 1 constitute the partition portions 29, and therefore it is also possible to prevent the conductor portions 1 from interfering with each other in the insulating member 2.

Also, in the present embodiment, the first insulating member 21 and the second insulating member 22 are films that are made of resin, and the insulating member 2 includes the first insulating member 21 and the second insulating member 22 that are joined to each other by performing welding. In this case, it is possible to easily attach the insulating member 2 to the conductor portions 1 by performing welding in a situation where the first insulating member 21 and the second insulating member 22 are placed on each other.

### Second Embodiment

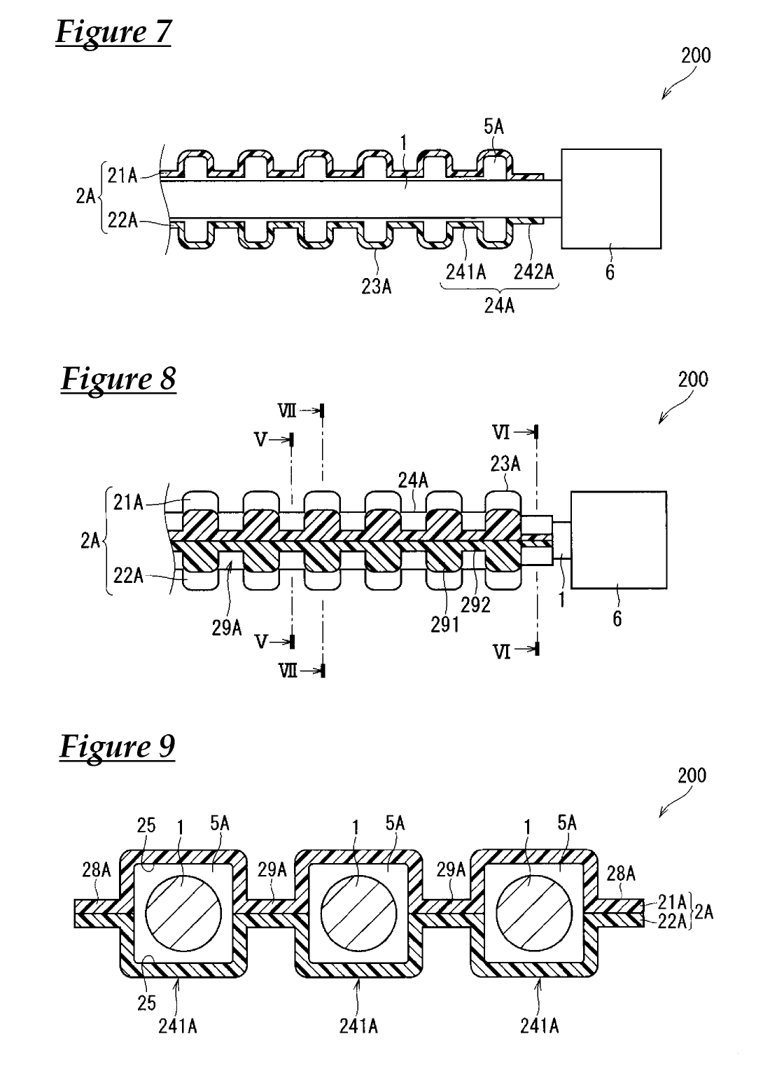

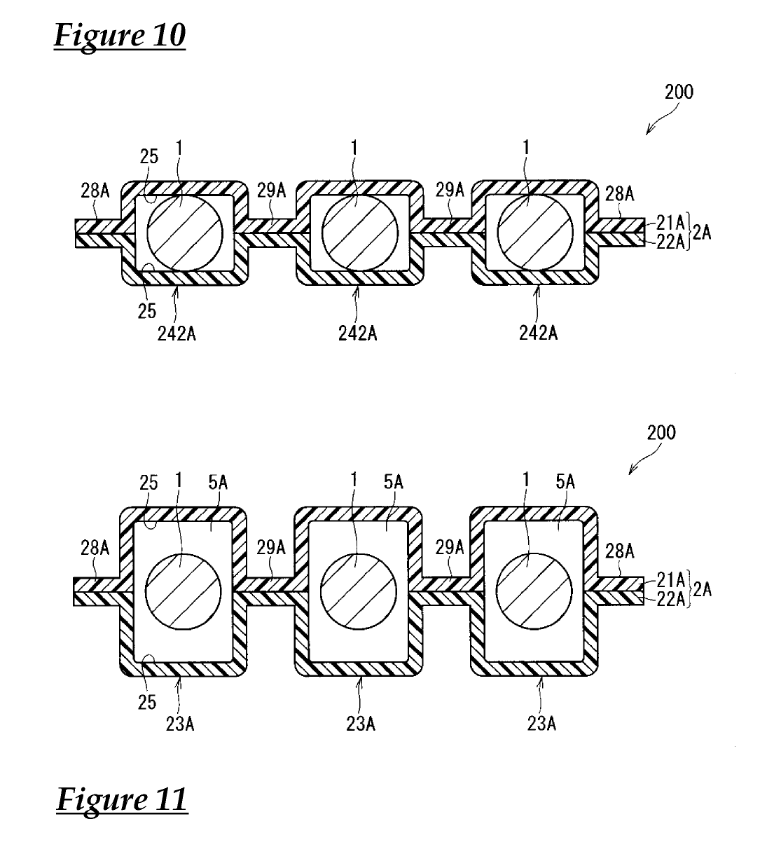

Next, an electrical wire 200 according to a second embodiment will be described with reference to FIGS. 6 to 11. The electrical wire 200 includes an insulating member 2A that is different from that in the first embodiment. FIG. 5 is a plan view of the electrical wire 200. FIG. 7 is a partially-cutout side view of an end portion of the electrical wire 200. FIG. 8 is a cross-sectional view of the end portion of the electrical wire 200. FIG. 8 is a cross-sectional view of the electrical wire 200 along a IV-IV plane shown in FIG. 6. FIG. 9 is a cross-sectional view of the electrical wire 200. FIG. 9 is a cross-sectional view of the electrical wire 200 along a V-V plane shown in FIG. 8. FIG. 10 is a cross-sectional view of the electrical wire 200. FIG. 10 is a cross-sectional view of the electrical wire 200 along a VI-VI plane shown in FIG. 8. FIG. 11 is a cross-sectional view of the electrical wire 200. FIG. 11 is a cross-sectional view of the electrical wire 200 along a VII-VII plane shown in FIG. 8. Note that, in FIGS. 6 to 11, the constituent elements that are the same as those shown in FIGS. 1 to 5 are assigned the same reference signs. The following describes the present embodiment in terms of differences from the first embodiment.

In the present embodiment, the electrical wire 200 includes the conductor portions 1 and the insulating member 2A. The electrical wire 200 includes three conductor portions 1 as in the first embodiment. As shown in FIG. 6, also in the present embodiment, the connection members 6 are connected to end portions of the conductor portions 1. The configurations of the conductor portions 1 and the connection members 6 are the same as those in the first embodiment, and therefore descriptions thereof are omitted.

In the electrical wire 200, the insulating member 2A includes a first insulating member 21A and a second insulating member 22A that are molded members made of resin, and at least one of the first insulating member 21A and the second insulating member 22A is provided with groove portions 25 that allow the conductor portions 1 to be disposed therein. Note that, as shown in FIGS. 9 to 11, the present embodiment is an example in which both the first insulating member 21A and the second insulating member 22A are provided with the groove portions 25.

In the present embodiment, the first insulating member 21A and the second insulating member 22A are molded members that are made of a soft resin. That is to say, the insulating member 2A is formed by placing the first insulating member 21A and the second insulating member 22A, which have been made using a mold or the like, on each other, and joining them to each other. Note that the present embodiment is an example in which the first insulating member 21A and the second insulating member 22A are joined using thermal press fitting through which the first insulating member 21A and the second insulating member 22A are subjected to pressure while being heated. It is possible that the first insulating member 21A and the second insulating member 22A in the insulating member 2A are members that include thermoplastic elastomer such as polyester elastomer or butyl rubber, for example.

Also, in the present embodiment, the insulating member 2A includes partition portions 29A, external partition portions 28A, ridge portions 23A that are convex, and valley portions 24A that are concave.

In the electrical wire 200, the partition portions 29A are joined portions between adjacent conductor portions 1, and separate a plurality of conductor portions 1 (three conductor portions 1 in this example) from each other, as in the first embodiment. As shown in FIG. 6, the insulating member 2A includes two partition portions 29A.

In the present embodiment, as shown in FIG. 8, each partition portion 29A includes a thick portion 291 that is relatively thick, and a thin portion 292 that is relatively thin. In the electrical wire 200, the thick portions 291 and the thin portions 292 of the partition portions 29A are alternately and continuously formed in the lengthwise direction of the conductor portions 1.

In partition portion forming areas of the first insulating member 21A where the partition portions 29A of the insulating member 2A are formed, relatively thick portions and relatively thin portions are alternately and continuously formed. One surface of each partition portion forming area of the first insulating member 21A is formed so as to be flat, and the other surface is formed so as to be uneven. In the following description, regarding portions of the first insulating member 21A that constitute the partition portions 29A of the insulating member 2A, surfaces that are formed on one side so as to be flat are referred to as flat surfaces, and uneven surfaces on the other side are referred to as uneven surfaces. In the present embodiment, in partition portion forming areas of the second insulating member 22A where the partition portions 29A of the insulating member 2A are formed, relatively thick portions and relatively thin portions are alternately and continuously formed, and surfaces on one side are formed so as to be flat, and surfaces on the other side are formed so as to be uneven, as in the first insulating member 21A.

In the present embodiment, the first insulating member 21A and the second insulating member 22A are placed on each other such that the flat surfaces of the partition portion forming areas of the first insulating member 21A and the flat surfaces of the partition portion forming areas of the second insulating member 22A are in contact with each other, and the insulating member 2A is obtained by joining the first insulating member 21A and the second insulating member 22A in such a state to each other.

At this time, the relatively thick portions in the partition portion forming areas of the first insulating member 21A and the relatively thick portions in the partition portion forming areas of the second insulating member 22A are attached to each other so as to be aligned with each other.

In the insulating member 2A, portions where the first insulating member 21A and the second insulating member 22A are joined to each other in a state where the relatively thick portions in the partition portion forming areas of the first insulating member 21A and the relatively thick portions in the partition portion forming areas of the second insulating member 22A are aligned with each other constitute the thick portions 291. Also, portions where the relatively thin portions in the partition portion forming areas of the first insulating member 21A and the relatively thin portions in the partition portion forming areas of the second insulating member 22A are aligned with and joined to each other constitute the thin portions 292. In this case, due to the presence of the thin portions 292 that are relatively thin, it is relatively easier to bend the insulating member 2A in a direction in which thick portions 291 on both sides of a thin portion 292 by which the thick portions 291 are connected are brought closer to each other.

Also, in the present embodiment, the flat surfaces of the partition portion forming areas of the first insulating member 21A and the flat surfaces of the partition portion forming areas of the second insulating member 22A are entirely joined to each other. That is to say, the first insulating member 21A and the second insulating member 22A that have the partition portion forming areas in which thick portions and thin portions have been formed in advance are joined to each other, and thus the insulating member 2A is formed. However, it is also possible that the first insulating member 21A and the second insulating member 22A are made into one unit by joining some portions of the partition portion forming areas of the first insulating member 21A and the partition portion forming areas of the second insulating member 22A to each other.

In the electrical wire 200, as in the first embodiment, the external partition portions 28A separate conductor portions 1 that are located at the two ends in the first direction, and the outside, from each other. The external partition portions 28A are formed by joining the first insulating member 21A and the second insulating member 22A to each other. In the present embodiment, the external partition portions 28A are formed by welding the first insulating member 21A and the second insulating member 22A to each other.

Also in the present embodiment, it is possible that the partition portions 29A and the external partition portions 28A are bendable portions. For example, it is possible that the partition portions 29A and the external partition portions 28A are flexible portions that have a thickness that allows the partition portions 29A and the external partition portions 28A to be bent so that the connection members 6 that are connected to the ends of the conductor portions 1 can be brought closer to each other.

In the electrical wire 200, the insulating member 2A includes the ridge portions 23A and the valley portions 24A. As in the first embodiment, the ridge portions 23A are formed in the second direction that intersects the lengthwise direction of the conductor portions 1. The valley portions 24A are also formed in the second direction. The ridge portions 23A and the valley portions 24A are alternately and continuously formed in the lengthwise direction of the conductor portions 1. That is to say, the insulating member 2A has a bellow structure in which the ridge portions 23A that are convex and the valley portions 24A that are concave are alternately and continuously arranged in the lengthwise direction of the conductor portions 1.

In the present embodiment, each valley portion 24A includes a first valley portion 241A and a second valley portion 242A. As shown in FIG. 9, the first valley portions 241A are valley portions that allow spaces 5A to be formed between the inner surfaces of the first valley portions 241A and the outer surfaces of the conductor portions 1. That is to say, as shown in FIG. 9, the vertical size and the horizontal size of the contours of the inner surfaces of the first valley portions 241A are both greater than the vertical size and the horizontal size of the contours of the outer surfaces of the conductor portions 1. That is to say, the first valley portions 241A also make it possible to secure sufficient spaces 5A in which the conductor portions 1 can be deformed such that the outer surfaces of the conductor portions 1 are not brought into contact with the inner surface of the insulating member 2A.

On the other hand, as shown in FIG. 6, the second valley portions 242A are formed at at least one end portion out of the two end portions of each conductor portion 1 in the lengthwise direction thereof (at both end portions in this example). As shown in FIG. 10, in the present embodiment, the inner surfaces of the second valley portions 242A are in contact with the outer surfaces of the conductor portions 1 that are housed in the insulating member 2A, so as to be separable from the outer surfaces. In this case, the second valley portions 242A prevent the insulating member 2A from significantly moving relative to the conductor portions 1. Note that, as in the first embodiment, the inner surfaces of the second valley portions 242A and the outer surfaces of the conductor portions 1 are in contact with each other so as to be separable from each other.

Also, in the present embodiment, the ridge portions 23A are curved and convex on the outer surface side of the insulating member 2A. As shown in FIG. 7, each ridge portion 23A includes a first surface that is parallel with the main surface of the insulating member 2A, and a plurality of second surfaces that are orthogonal to the first surface, and these surfaces are continuously formed so as to be convex.

Also in the present embodiment, as shown in FIG. 7, when the ridge portions 23A are viewed from the inner surface side of the insulating member 2A, the openings of the ridge portions 23A are formed as grooves that face toward the conductor portions 1 inside the insulating member 2A. Consequently, also in the present embodiment, as shown in FIG. 11, the spaces 5A that allow the conductor portions 1 to be freely deformed are formed between the inner surfaces of the ridge portions 23A and the outer surfaces of the conductor portions 1.

In the present embodiment, as shown in FIGS. 9 to 11, the first insulating member 21A and the second insulating member 22A are provided with the groove portions 25 that allow the conductor portions 1 to be disposed therein. Therefore, it is possible to form the groove portions 25 along the entire length of the first insulating member 21A and the second insulating member 22A in the lengthwise direction of the conductor portions 1.

In the present embodiment, the first insulating member 21A and the second insulating member 22A are brought closer to each other in a situation where the openings of the groove portions 25 of the first insulating member 21A and the openings of the groove portions 25 of the second insulating member 22A face each other. At this time, the conductor portions 1 are housed in spaces that are surrounded by the groove portions 25 of the first insulating member 21A and the groove portions 25 of the second insulating member 22A.

Therefore, it is possible for each groove portion 25 to have a depth that allows at least a portion of a conductor portion 1 to be housed therein. Note that, if the first insulating member 21A and the second insulating member 22A are provided with the groove portions 25, it is possible that the sum of the depths of two groove portions 25 is greater than the diameter of the conductor portions 1. Also, if only one out of the first insulating member 21A and the second insulating member 22A is provided with the groove portions 25, it is possible that the depth of the groove portions 25 of this one member is larger than the diameter of the conductor portions 1. Note that, if only one out of the first insulating member 21A and the second insulating member 22A is provided with the groove portions 25, it is possible that a surface of the member that is not provided with the groove portions 25, the surface facing the groove portions 25, is formed so as to be flat, for example.

In the present embodiment, when the task of making the first insulating member 21A and the second insulating member 22A into one unit is to be performed, it is possible to fix the positions of the conductor portions 1 by disposing the conductor portions 1 in the groove portions 25. Therefore, it is possible to improve workability when performing the task of joining the first insulating member 21A and the second insulating member 22A to each other.

Also in the present embodiment, the inner surface of the insulating member 2A and the outer surfaces of the conductor portions 1 are provided so as to be separable from each other. That is to say, the insulating member 2A is not fixed to the outer surfaces of the conductor portions 1. Therefore, the insulating member 2A that wraps around the conductor portions 1 deforms at positions that correspond to the deformation of the conductor portions 1. Consequently, it is possible to reduce the force required to bend the electrical wire 200, and it is possible to further improve the flexibility of the electrical wire 200.

Also, in the present embodiment, the insulating member 2A includes the first insulating member 21A and the second insulating member 22A that are molded members made of resin, and at least one (both in this example) of the first insulating member 21A and the second insulating member 22A is provided with the groove portions 25 that allow the conductor portions 1 to be disposed therein. In this case, it is possible to attach the insulating member 2A to the conductor portions 1 by performing a simple task of attaching the first insulating member 21A and the second insulating member 22A to the conductor portions 1 so as to sandwich the conductor portions 1 from both sides.

### Third Embodiment

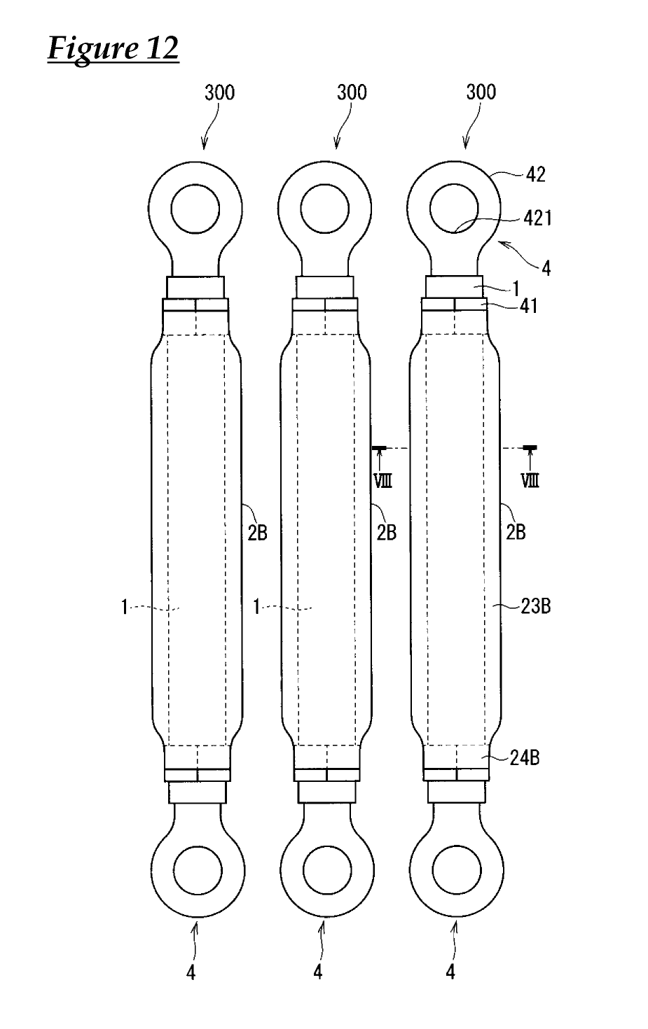

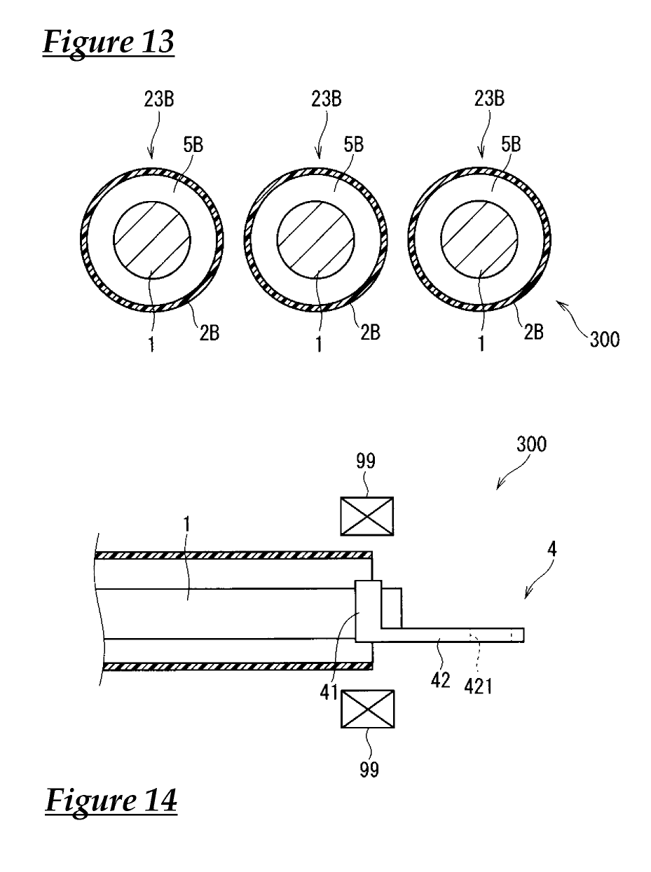

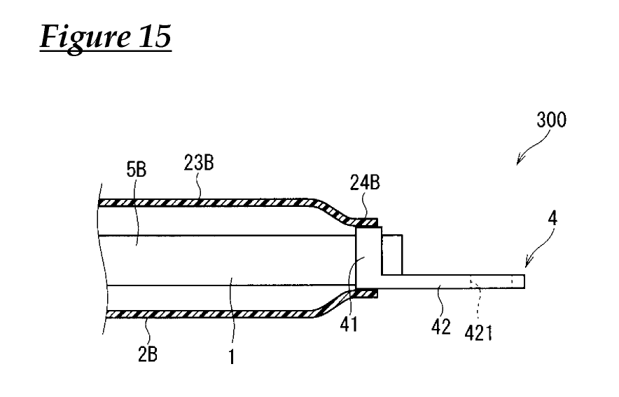

Next, terminal-equipped electrical wires 300 according to a third embodiment will be described with reference to FIGS. 12 to 15. Each terminal-equipped electrical wire 300 includes insulating members 2B that are different from those in the first embodiment and the second embodiment. FIG. 12 is a plan view of the terminal-equipped electrical wires 300. FIG. 13 is a cross-sectional view of the terminal-equipped electrical wires 300. FIG. 13 is a cross-sectional view of the terminal-equipped electrical wires 300 along a VIII-VIII plane shown in FIG. 12. FIG. 14 is a partially-cutout side view of an end portion of a terminal-equipped electrical wire 300 in a partially-disassembled state. Note that FIG. 14 shows the process of attaching the insulating members 2B to the terminal-equipped electrical wire 300. FIG. 15 is a partially-cutout side view of an end portion of a terminal-equipped electrical wire 300. Note that, in FIGS. 12 to 15, the constituent elements that are the same as those shown in FIGS. 1 to 11 are assigned the same reference signs. The following describes the present embodiment in terms of differences from the first embodiment and the second embodiment.

In the present embodiment, the terminal-equipped electrical wires 300 include the conductor portions 1, the insulating members 2B, and terminals 4. Note that FIGS. 12 and 13 show a state in which three terminal-equipped electrical wires 300 are arranged in parallel. The configurations of the conductor portions 1 are the same as those in the first embodiment, and therefore descriptions thereof are omitted.

In each terminal-equipped electrical wire 300, terminals 4 are respectively connected to the two end portions of a conductor portion 1. In the present embodiment, as shown in FIG. 12, each terminal 4 includes a conductor connection portion 41 that is connected to a conductor portion 1 and a connection point portion 42 that is a portion that is connectable to a partner member that is a connection partner of the terminal 4.

In the present embodiment, the conductor connection portions 41 are portions that are connected to end portions of the conductor portions 1. As shown in FIGS. 12, 14, and 15, the conductor connection portions 41 are connected to the end portions of the conductor portions 1 by being press-fitted thereto. That is to say, in the present embodiment, each conductor connection portion 41 includes a press-fitting piece that is swaged in a state of wrapping around an end portion of a conductor portion 1.

Note that it is also possible that the conductor portions 1 are connected to the terminals 4 by performing welding such as ultrasonic welding, heat welding, or the like. If this is the case, it is possible that the conductor connection portions 41 are formed so as to have a flat plate-like shape.

Also, in the present embodiment, the connection point portions 42 are formed so as to extend from the conductor connection portions 41 to the opposite side relative to the conductor portions 1 side in the lengthwise direction of the conductor portions 1. Also, as shown in FIG. 12, each connection point portion 42 includes a fastening hole 421 that allows for fastening to a partner member using a bolt. Each fastening hole 421 is a through hole that penetrates from one main surface to the other main surface of a terminal 4. In this case, it is possible that a partner member is also provided with a fastening hole that allows for fastening to a terminal 4 using a bolt. A bolt can be inserted and fastened in a situation where the fastening hole 421 of a connection point portion 42 of a terminal 4 and a fastening hole of a partner member are aligned with each other, thus connecting the terminal 4 and the partner member to each other.

In each terminal-equipped electrical wire 300, the insulating member 2B is a heat shrink tube that is in intimate contact with the circumferential surfaces of the terminals 4 at the two end portions of the insulating member 2B, and has shrunk due to heat having been applied thereto. In the present embodiment, each insulating member 2B includes: intimate contact portions 24B that are located at the two end portions of the insulating member 2B and have shrunk due to heat having been applied thereto; and a space forming portion 23B that is a portion between the intimate contact portions 24B and is in a pre-shrinkage state.

In each insulating member 2B, as shown in FIGS. 14 and 15, each intimate contact portion 24B is a portion where a heat shrink tube in a pre-shrinkage state has shrunk due to heat having been applied thereto by heating devices 99 such as heaters. The inner surfaces of the intimate contact portions 24B of the insulating members 2B are in intimate contact with the outer circumferential surfaces of the terminals 4. Note that, in the present embodiment, the intimate contact portions 24B wrap around the conductor connection portions 41 of the terminal 4.

The space forming portions 23B are portions of heat shrink tubes in a pre-shrinkage state. That is to say, the insulating members 2B include the space forming portions 23B that are portions of heat shrink tubes in a pre-shrinkage state, and the intimate contact portions 24B that are portions where the heat shrink tubes have shrunk due to heat having been applied thereto. Therefore, in the present embodiment, the space forming portions 23B have an inner diameter larger than that of the intimate contact portions 24B.

In the insulating members 2B, the contours of the inner surfaces of the space forming portions 23B are larger than the contours of the outer surfaces of the conductor portions 1. Therefore, as shown in FIGS. 13 and 15, the spaces 5B are formed between the inner surfaces of the space forming portions 23B and the outer surfaces of the conductor portions 1. Note that, as in the first embodiment and the second embodiment, the spaces 5B are spaces that allow the conductor portions 1 to freely deform such that the outer surfaces of the conductor portions 1 are not brought into contact with the inner surfaces of the insulating members 2B. However, it is also possible that the inner surfaces of the space forming portions 23B are in contact with the outer surfaces of the conductor portions 1 so as to be separable from the outer surfaces.

The heat shrink tubes that constitute the insulating members 2B are, for example, tubular members that are made of a synthetic resin such as a polyolefin-based synthetic resin, a nylon-based synthetic resin, a silicone-based synthetic resin, a Fluorine-based synthetic resin, or a polyester elastomer-based synthetic resin. The heat shrink tubes are each obtained by stretching a resin member that has been formed in a very narrow tubular shape using extrusion molding, so as to have a wide tubular shape, while the resin member is heated, and then cooling the resin member. The heat shrink tubes thus obtained have shape memory characteristics with which the heat shrink tubes, when heated, shrink to the narrow tubular shape that is the shape thereof prior to stretching being performed.

It is also possible that the intimate contact portions 24B of the insulating member 2B and the terminals 4 are bonded to each other by an adhesive. If this is the case, it is possible that the inner surfaces of the heat shrink tubes that constitute the insulating members 2B are provided with a thermoplastic adhesive, for example. Note that the adhesive is preferably provided at only end portions of the heat shrink tubes. This is because only end portions of the heat shrink tube before shrinkage are heated in the present embodiment. Also, in a case where only end portions of the heat shrink tubes are provided with an adhesive, even if portions that correspond to the space forming portions 23B of the heat shrink tubes before shrinkage are heated by mistake, the inner surfaces of the space forming portions 23B are prevented from bonding to the outer surfaces of the conductor portions 1 due to the adhesive. It is also possible that an adhesive is provided on the terminal 4 side. That is to say, it is also possible that an adhesive is applied to the outer surfaces of the terminals 4, for example.

Also in the present embodiment, the inner surfaces of the insulating members 2B and the outer surfaces of the conductor portions 1 are provided so as to be separable from each other. That is to say, the insulating members 2B are not fixed to the outer surfaces of the conductor portions 1. Therefore, the insulating members 2B that wrap around the conductor portions 1 deform at positions that correspond to the deformation of the conductor portions 1. Consequently, it is possible to reduce the force required to bend the terminal-equipped electrical wires 300, and it is possible to further improve the flexibility of the terminal-equipped electrical wires 300.

Also, in the present embodiment, each insulating member 2B is a heat shrink tube that is in intimate contact with the circumferential surfaces of the terminals 4 at the two end portions of the insulating member 2B, and has shrunk due to heat having been applied thereto. In this case, it is possible to attach the insulating members 2B to the conductor portions 1 by performing a simple task of applying heat to the heat shrink tubes so as to shrink the heat shrink tubes.

Also, in the present embodiment, each insulating member 2B includes: the intimate contact portions 24B that are located at the two end portions of the insulating member 2B, and have shrunk due to heat having been applied thereto; and the space forming portion 23B that is a portion between the intimate contact portions 24B and is in a pre-shrinkage state. In this case, it is possible to attach the insulating members 2B to the conductor portions 1 by applying heat to the end portions of the heat shrink tubes so as to shrink the end portions. That is to say, there is no need to apply heat to the entire heat shrink tubes, and it is possible to reduce the time that is required to manufacture the terminal-equipped electrical wires 300.

### Fourth Embodiment

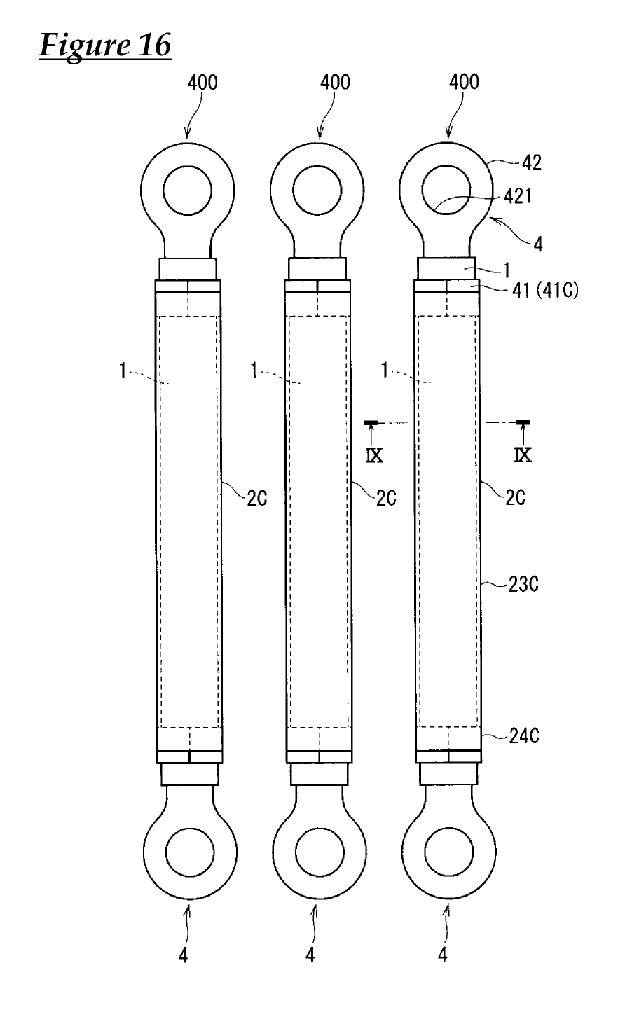

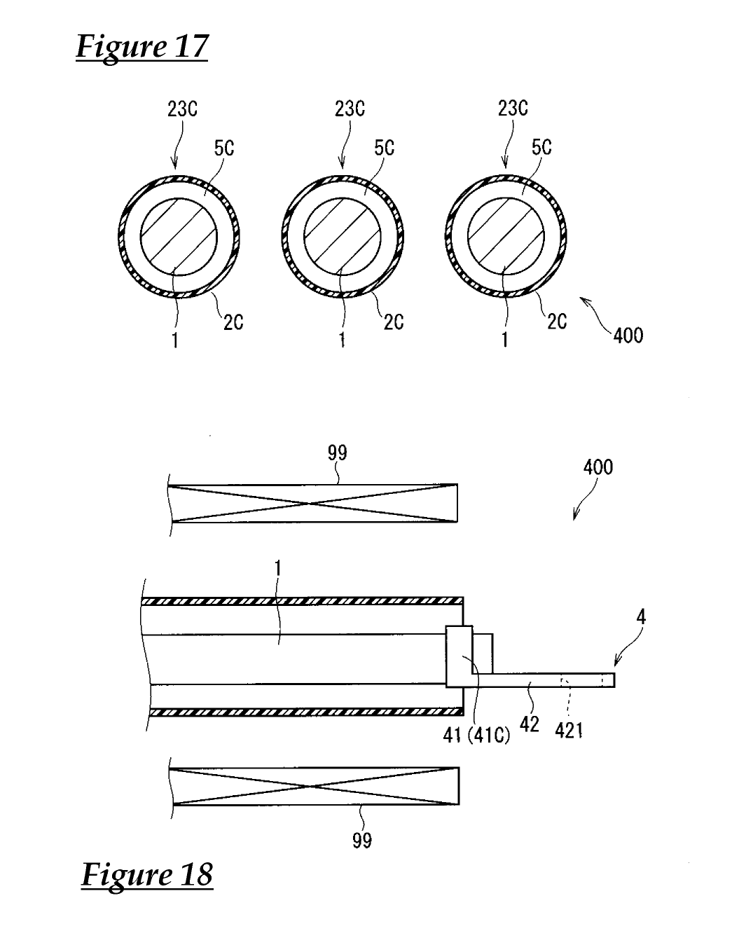

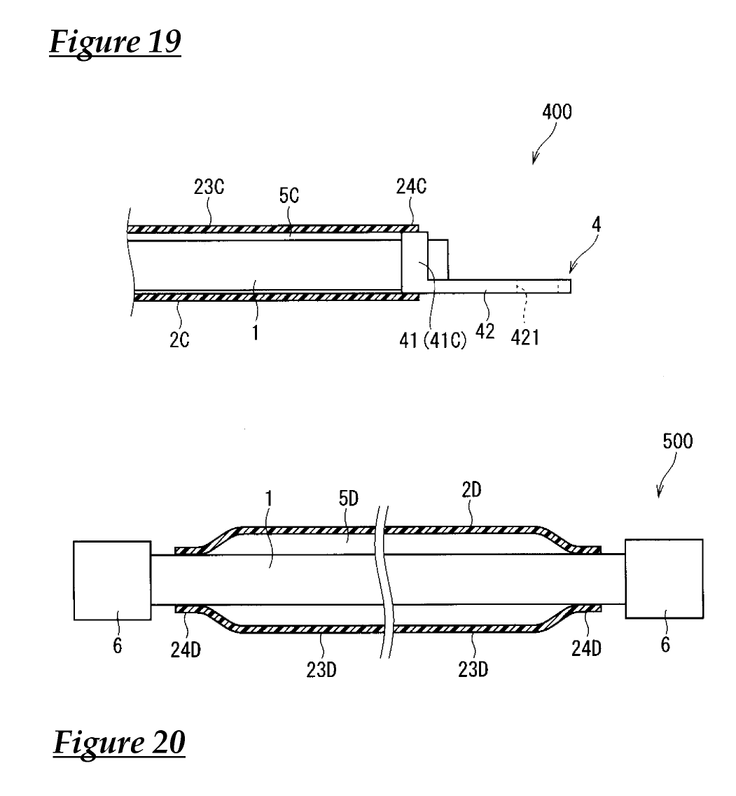

Next, a terminal-equipped electrical wire 400 according to a fourth embodiment will be described with reference to FIGS. 16 to 19. The terminal-equipped electrical wire 400 includes insulating members 2C that are different from those in the first embodiment to the third embodiment. FIG. 16 is a plan view of the terminal-equipped electrical wire 400. FIG. 17 is a cross-sectional view of the terminal-equipped electrical wire 400. FIG. 17 is a cross-sectional view of the terminal-equipped electrical wire 400 along a IX-IX plane shown in FIG. 16. FIG. 18 is a partially-cutout side view of an end portion of the terminal-equipped electrical wire 400 in a partially-disassembled state. Note that FIG. 18 shows the process of attaching the insulating members 2C to the terminal-equipped electrical wire 400. FIG. 19 is a partially-cutout side view of an end portion of the terminal-equipped electrical wire 400. Note that, in FIGS. 16 to 19, the constituent elements that are the same as those shown in FIGS. 1 to 15 are assigned the same reference signs. The following describes the present embodiment in terms of differences from the first embodiment to the third embodiment.

In the present embodiment, the terminal-equipped electrical wires 400 include the conductor portions 1, the insulating members 2C, and the terminals 4. Note that FIGS. 16 and 17 show a state in which three terminal-equipped electrical wires 400 are arranged in parallel. The configurations of the conductor portions 1 are the same as those in the first embodiment, and therefore descriptions thereof are omitted.

In each terminal-equipped electrical wire 400, terminals 4 are respectively connected to the two end portions of a conductor portion 1, as in the third embodiment. Also in the present embodiment, each terminal 4 includes a conductor connection portion 41 that is connected to a conductor portion 1 and a connection point portion 42 that is a portion that is connectable to a partner member that is a connection partner of the terminal 4.

In the terminal-equipped electrical wires 400, each terminal 4 includes an insulating member fixing portion 41C that has a contour larger than the contours of the conductor portions 1. The present embodiment is an example in which the insulating member fixing portions 41C are the conductor connection portions 41 of the terminals 4.

In the terminal-equipped electrical wires 400, each insulating member 2C is a heat shrink tube that is in intimate contact with the circumferential surfaces of the terminals 4 at the two end portions of the insulating member 2C, and has shrunk due to heat having been applied thereto. In the present embodiment, each insulating member 2C is a heat shrink tube that has shrunk along the entire length thereof due to heat having been applied thereto. Each insulating member 2C includes: intimate contact portions 24C that are in intimate contact with the circumferential surfaces of the insulating member fixing portions 41C of the terminals 4; and a space forming portion 23C whose inner surface after heat shrinkage has a contour that is larger than the contour of the conductor portion 1 so that a space 5C is formed between the space forming portion 23C and the outer surface of the conductor portion 1.

That is to say, as described above, the heat shrink tubes are each obtained by stretching a resin member that has been formed in a very narrow tubular shape using extrusion molding, so as to have a wide tubular shape, while the resin member is heated, and then cooling the resin member. The heat shrink tubes thus obtained have shape memory characteristics with which the heat shrink tubes, when heated, shrink to the narrow tubular shape that is the shape thereof prior to stretching being performed. In the present embodiment, the heat shrink tubes that constitute the insulating members 2C are heat shrink tubes whose inner surfaces, when the heat shrink tubes have not been stretched and are in the narrow tubular shape, have contours that are larger than the contours of the outer surfaces of the conductor portions 1, and are smaller than the contours of the outer surfaces of the insulating member fixing portions 41C of the terminals 4.

In each insulating member 2C, as shown in FIG. 18, the heat shrink tube before shrinkage is heated along the entire length thereof by the heating devices 99 such as heaters. Here, the heat shrink tubes that constitute the insulating members 2C are heat shrink tubes whose inner surfaces, when the heat shrink tubes have not been stretched and are in the narrow tubular shape, have contours that are larger than the contours of the outer surfaces of the conductor portions 1, and are smaller than the contours of the outer surfaces of the insulating member fixing portions 41C of the terminals 4. Therefore, the heat shrink tubes that have shrunk due to heat having been applied thereto are in intimate contact with the outer surfaces of the insulating member fixing portions 41C of the terminals 4, but are not in intimate contact with the outer surfaces of the conductor portions 1, and the spaces 5C are formed between the thus shrunken heat shrink tubes and the conductor portions 1.

In the insulating members 2C, the intimate contact portions 24C are portions of the heat shrink tubes that have shrunk due to heat having been applied thereto. The inner surfaces of the intimate contact portions 24C are in intimate contact with the outer circumferential surfaces of the insulating member fixing portions 41C (the conductor connection portions 41 in this example) of the terminals 4.

In the insulating members 2C, the space forming portions 23C are also portions of the heat shrink tubes that have shrunk due to heat having been applied thereto. Therefore, in the present embodiment, it is possible that the inner diameter of the space forming portions 23C and the inner diameter of the intimate contact portions 24C are the same.

As described above, in the insulating members 2C, the contours of the inner surfaces of the space forming portions 23C are larger than the contours of the outer surfaces of the conductor portions 1. Therefore, as shown in FIG. 17, the spaces 5C are formed between the inner surfaces of the space forming portions 23C and the outer surfaces of the conductor portions 1. Note that, as in the first embodiment to the third embodiment, the spaces 5C are spaces that allow the conductor portions 1 to freely deform such that the outer surfaces of the conductor portions 1 are not brought into contact with the inner surfaces of the insulating members 2C.

Also in the present embodiment, the inner surfaces of the insulating members 2C and the outer surfaces of the conductor portions 1 are provided so as to be separable from each other. That is to say, the insulating members 2C are not fixed to the outer surfaces of the conductor portions 1. Therefore, the insulating members 2C that wrap around the conductor portions 1 deform at positions that correspond to the deformation of the conductor portions 1. Consequently, it is possible to reduce the force required to bend the terminal-equipped electrical wires 400, and it is possible to further improve the flexibility of the terminal-equipped electrical wires 400.

Also, in the present embodiment, each insulating member 2C is a heat shrink tube that is in intimate contact with the circumferential surfaces of the terminals 4 at the two end portions of the insulating member 2C, and has shrunk due to heat having been applied thereto. In this case, it is possible to attach the insulating members 2C to the conductor portions 1 by performing a simple task of applying heat to the heat shrink tubes to shrink the heat shrink tubes.

Also, in the present embodiment, the insulating members 2C are heat shrink tubes that have shrunk along the entire length due to heat having been applied thereto, and the insulating members 2C include the intimate contact portions 24C that are in intimate contact with the circumferential surfaces of the insulating member fixing portions 41C of the terminals 4, and the space forming portions 23C whose inner surfaces have contours that are larger than the contours of the conductor portions 1 so that the spaces 5C are formed between the space forming portions 23C and the outer surfaces of the conductor portions 1. In this case, it is possible to attach the insulating members 2C to the conductor portions 1 by performing a simple task of applying heat to the entire heat shrink tubes so as to shrink the heat shrink tubes.

### Fifth Embodiment

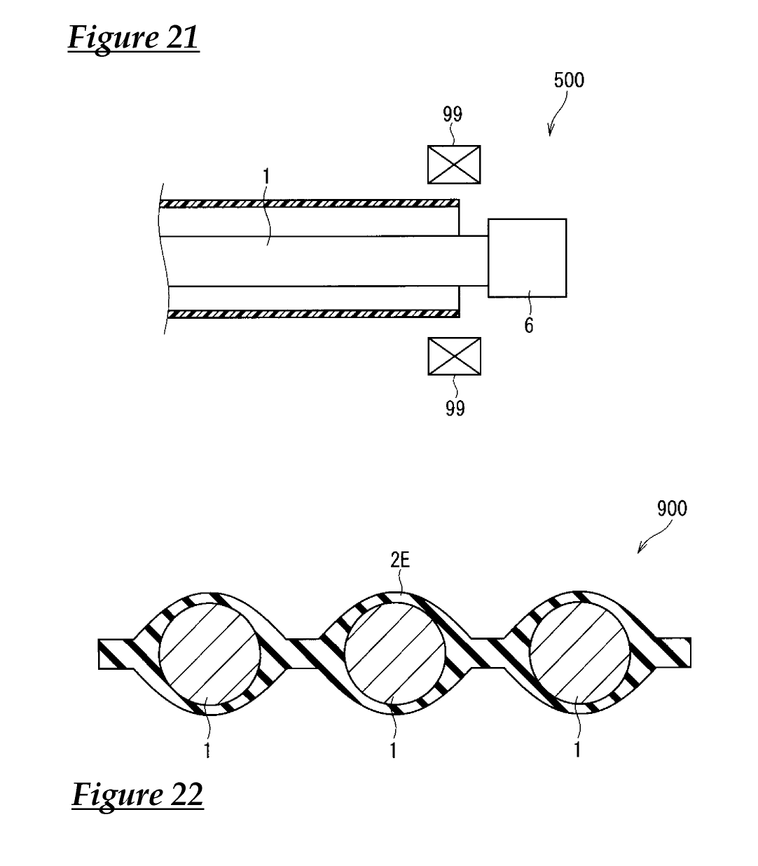

Next, an electrical wire 500 according to a fifth embodiment will be described with reference to FIGS. 20 and 21. The electrical wire 500 includes insulating members 2D that are different from those in the first embodiment to the fourth embodiment. FIG. 20 is a partially-cutout side view of the electrical wire 500. FIG. 21 is a partially-cutout side view of the electrical wire 500 in a partially-disassembled state. Note that FIG. 21 shows the process of attaching the insulating members 2D to the electrical wire 500. Note that, in FIGS. 20 to 21, the constituent elements that are the same as those shown in FIGS. 1 to 19 are assigned the same reference signs. The following describes the present embodiment in terms of differences from the first embodiment to the fourth embodiment.

In the present embodiment, the electrical wire 500 includes the conductor portions 1 and the insulating members 2D. Note that, in the present embodiment, as in the first embodiment, the connection members 6 are connected to end portions of the conductor portions 1. The configurations of the conductor portions 1 and the connection members 6 are the same as those in the first embodiment, and therefore descriptions thereof are omitted.

In the electrical wire 500, the insulating members 2D are heat shrink tubes that have shrunk due to heat having been applied thereto. Each insulating member 2D includes: intimate contact portions 24D that are located at the two end portions of the insulating member 2D, have shrunk due to heat having been applied thereto, and are in intimate contact with the circumferential surface of the conductor portion 1; and a space forming portion 23D that is a portion between the intimate contact portions 24D and is in a pre-shrinkage state.

In each insulating member 2D, as shown in FIG. 21, each intimate contact portion 24D is a portion where a heat shrink tube in a pre-shrinkage state is shrunk due to heat having been applied thereto by heating devices 99 such as heaters. The inner surfaces of the intimate contact portions 24D of the insulating members 2D are in intimate contact with the outer circumferential surfaces of the conductor portions 1.

The space forming portions 23D are portions of heat shrink tubes in a pre-shrinkage state. That is to say, the insulating members 2D include the space forming portions 23D that are portions of heat shrink tubes in a pre-shrinkage state, and the intimate contact portions 24D that are portions where the heat shrink tubes have shrunk due to heat having been applied thereto. Therefore, in the present embodiment, the space forming portions 23D have an inner diameter larger than that of the intimate contact portions 24D.

In the insulating members 2D, the contours of the inner surfaces of the space forming portions 23D are larger than the contours of the outer surfaces of the conductor portions 1. Therefore, as shown in FIG. 20, the spaces 5D are formed between the inner surfaces of the space forming portions 23D and the outer surfaces of the conductor portions 1. Note that, as in the first embodiment to the fourth embodiment, the spaces 5D are spaces that allow the conductor portions 1 to freely deform such that the outer surfaces of the conductor portions 1 are not brought into contact with the inner surfaces of the insulating members 2D. However, it is also possible that the inner surfaces of the space forming portions 23D are in contact with the outer surfaces of the conductor portions 1 so as to be separable from the outer surfaces.

Also in the present embodiment, the inner surfaces of the insulating members 2D and the outer surfaces of the conductor portions 1 are provided so as to be separable from each other. That is to say, the insulating members 2D are not fixed to the outer surfaces of the conductor portions 1. Therefore, the insulating members 2D that wrap around the conductor portions 1 deform at positions that correspond to the deformation of the conductor portions 1. Consequently, it is possible to reduce the force required to bend the electrical wire 500, and it is possible to further improve the flexibility of the electrical wire 500.

Also, in the present embodiment, each insulating member 2D is a heat shrink tube that has shrunk due to heat having been applied thereto, and includes: the intimate contact portions 24D that are located at the two end portions of the insulating member 2D, have shrunk due to heat having been applied thereto, and are in intimate contact with the circumferential surface of the conductor portion 1; and the space forming portion 23D that is a portion between the intimate contact portions 24D and is in a pre-shrinkage state. In this case, it is possible to attach the insulating members 2D to the conductor portions 1 by applying heat to the end portions of the heat shrink tubes to shrink the end portions. That is to say, there is no need to apply heat to the entirety of the heat shrink tubes, and it is possible to reduce the time that is required to manufacture the electrical wire 500.

### Referential Example

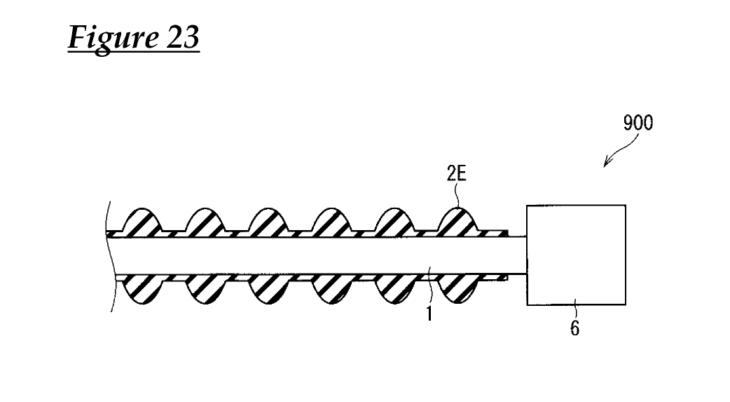

Next, an electrical wire 900 according to a referential example will be described. FIG. 22 is a cross-sectional view of the electrical wire 900. FIG. 23 is a partially-cutout side view of the electrical wire 900. The electrical wire 900 includes the conductor portions 1 and an insulating member 2E. Also, the connection members 6 are connected to end portions of the conductor portions 1. FIG. 22 shows a case in which the electrical wire 900 includes a plurality of conductor portions 1 (three conductor portions 1 in this example). Note that, in FIGS. 22 and 23, the constituent elements that are the same as those shown in FIGS. 1 to 22 are assigned the same reference signs. The configurations of the conductor portions 1 and the connection members 6 are the same as those in the first embodiment, and therefore descriptions thereof are omitted.

The insulating member 2E is a flexible member that is made of resin. It is possible that the resin that is included in the insulating member 2E is an elastomer or the like, for example. The insulating member 2E is formed through insertion molding of a resin that constitutes the insulating member 2E, where the conductor portions 1 are inserted articles. That is to say, in the electrical wire 900, the insulating member 2E is fixed to the outer circumferential surfaces of the conductor portions 1.

Also, the insulating member 2E has a configuration in which thick portions 23E that are thick and thin portions 24E that are thin are alternately and continuously arranged in the lengthwise direction of the conductor portions 1. In this case, due to the presence of the thin portions 24E that are relatively flexible, it is relatively easier to bend the insulating member 2E in a direction in which thick portions 23E on both sides of a thin portion 24E by which the thick portions 23E are connected are brought closer to each other.

In this referential example, it is easy to bend the electrical wire 900 due to the presence of the flexible insulating member 2E and the conductor portions 1. Also, the insulating member 2E has a configuration in which the thick portions 23E that are thick and the thin portions 24E that are thin are alternately and continuously arranged in the lengthwise direction of the conductor portions 1, and therefore it is easier to bend the insulating member 2E.

### Application Examples

In the first embodiment, it is also possible that the insulating member 2 is formed by bonding the first insulating member 21 and the second insulating member 22 to each other using an adhesive. The same applies to the second embodiment.

In the second embodiment, it is also possible that the insulating member 2A is formed by bonding the first insulating member 21A and the second insulating member 22A in which each partition portion forming area has a uniform thickness, to each other. In this case, the first insulating member 21A and the second insulating member 22A are joined by performing thermal press fitting from two sides, at a plurality of positions, in a situation where the partition portion forming areas of the first insulating member 21A and the partition portion forming areas of the second insulating member 22A are aligned with each other. That is to say, the first insulating member 21A and the second insulating member 22A are joined to each other at the positions on which thermal press fitting has been performed. In the insulating member 2A, the portions on which thermal press fitting has been performed constitute the thin portions 292, and the portions on which thermal press fitting has not been performed constitute the thick portions 291.

In the third embodiment and the fourth embodiment, it is also possible that the terminal-equipped electrical wires 300 and 400 are provided with terminal members other than the terminals, such as connectors, instead of the terminals 4 that are connected to the end portions of the conductor portions 1.

Note that it is possible that the electrical wires and the terminal-equipped electrical wires according to the present invention are configured by freely combining the above-described embodiments and application examples with each other, modifying the embodiments and the application examples, or omitting some portions of the embodiments and the application examples as appropriate.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### REFERENCE SIGNS LIST

1: Conductor Portion

100: Electrical Wire

2: Insulating Member

21: First Insulating Member

22: Second Insulating Member

23: Ridge Portion

23B: Space Forming Portion

24: Valley Portion

24B: Intimate Contact Portion

29: Partition Portion

300: Terminal-equipped Electrical Wire

4: Terminal

41C: Insulating Member Fixing Portion

5: Space

1. An electrical wire comprising:
a conductor portion that is flexible and is made of metal; and
an insulating member that wraps around the conductor portion,
wherein an inner surface of the insulating member and an outer surface of the conductor portion are provided so as to be separable from each other, and
the insulating member includes a first insulating member and a second insulating member that wrap around the conductor portion by being brought closer to the conductor portion from two sides and being joined to each other on both sides of the conductor portion.

2. The electrical wire according to claim 1,
wherein, in at least some portions of the electrical wire, a space is provided between the inner surface of the insulating member and the outer surface of the conductor portion.

3. The electrical wire according to claim 1,
wherein the insulating member has a bellow structure in which ridge portions that are convex and extend in a direction that intersects a lengthwise direction of the conductor portion, and valley portions that are concave and extend in a direction that intersects the lengthwise direction of the conductor portion, are alternately and continuously arranged in the lengthwise direction of the conductor portion.

4. The electrical wire according to claim 3,
wherein spaces are formed between inner surfaces of the ridge portions of the insulating member and the outer surface of the conductor portion.

5. (canceled)

6. The electrical wire according to claim 1,
wherein the first insulating member and the second insulating member are film members that are made of resin, and
the insulating member includes the first insulating member and the second insulating member that are joined to each other.

7. The electrical wire according to claim 1,
wherein the insulating member includes the first insulating member and the second insulating member that are molded members made of resin, and at least one of the first insulating member and the second insulating member is provided with a groove portion that allows the conductor portion to be disposed therein.

8. The electrical wire according to claim 1,
wherein the conductor portion is provided in a plurality, the plurality of conductors being arranged in parallel, and
the insulating member that wraps around the plurality of conductor portions together includes partition portions that are joined portions between adjacent conductor portions, and that separate the plurality of conductor portions from each other.

9. An electrical wire comprising:
a conductor portion that is flexible and is made of metal; and
an insulating member that wraps around the conductor portion,
wherein an inner surface of the insulating member and an outer surface of the conductor portion are provided so as to be separable from each other, and
the insulating member is a heat shrink tube that has shrunk due to heat having been applied thereto, and includes: intimate contact portions that are located at two end portions of the insulating member, have shrunk due to heat having been applied thereto, and are in intimate contact with a circumferential surface of the conductor portion; and a space forming portion that is a portion between the intimate contact portions and is in a pre-shrinkage state.

10. A terminal-equipped electrical wire comprising:
a conductor portion that is flexible and is made of metal; and
an insulating member that wraps around the conductor portion,
wherein an inner surface of the insulating member and an outer surface of the conductor portion are provided so as to be separable from each other,
the terminal-equipped electrical wire further comprises terminals that are respectively connected to two end portions of the conductor, and
the insulating member is a heat shrink tube whose two end portions are respectively in intimate contact with circumferential surfaces of the terminals, and have shrunk due to heat having been applied thereto.

11. The terminal-equipped electrical wire according to claim 10,
wherein the insulating member includes: intimate contact portions that are located at two end portions of the insulating member and have shrunk due to heat having been applied thereto; and a space forming portion that is a portion between the intimate contact portions and is in a pre-shrinkage state,
the intimate contact portions are in intimate contact with the circumferential surfaces of the terminals, and
a contour of an inner surface of the space forming portion is larger than a contour of the conductor portion, and a space is formed between the inner surface of the space forming portion and an outer surface of the conductor portion.

12. The terminal-equipped electrical wire according to claim 10,
wherein the terminals respectively include insulating member fixing portions whose contours are larger than a contour of the conductor portion, and
the insulating member is a heat shrink tube that has shrunk along an entire length thereof due to heat having been applied thereto, and includes: intimate contact portions that are in intimate contact with circumferential surfaces of the insulating member fixing portions of the terminals; and a space forming portion whose inner surface after heat shrinkage has a contour that is larger than a contour of the conductor portion so that a space is formed between the space forming portion and an outer surface of the conductor portion.
